(19) United States
(12) Patent Application Publication
(10) Pub. No.: US 2017/0070179 A1
(43) Pub. Date: Mar. 9, 2017

(54) MOTOR DRIVE HAVING FUNCTION OF DETECTING DC LINK CURRENT

(71) Applicant: FANUC CORPORATION, Yamanashi (JP)

(72) Inventor: Yuuichi Yamada, Yamanashi (JP)

(73) Assignee: FANUC CORPORATION, Yamanashi (JP)

(21) Appl. No.: 15/246,669

(22) Filed: Aug. 25, 2016

(30) Foreign Application Priority Data
Sep. 4, 2015 (JP) 2015-174984

(51) Int. Cl. H02P 29/40; H02P 6/08; H02P 27/08

(52) U.S. Cl. CPC H02P 29/40; H02P 27/08; H02P 6/08

(57) ABSTRACT

A motor drive according to the present invention includes an inverter circuit for converting a direct current into an alternating current by the switching of power elements and supplying the alternating current to a motor; a drive circuit for controlling the switching of the power elements; a fuse connected in series between a terminal of a DC link unit and a terminal of the inverter circuit through a conductor; a DC link current detection circuit for detecting a DC link current based on at least one of a voltage across the fuse, a voltage across a circuit including the fuse and part of the conductor, and a voltage across part of the conductor; and a DC link overcurrent detection circuit for detecting an overcurrent when the DC link current exceeds a predetermined value, and outputting a power element off command to turn off at least one of the power elements.

This application is a new U.S. patent application that claims benefit of JP 2015-174984 filed on Sep. 4, 2015, the content of 2015-174984 is incorporated herein by reference.

### BACKGROUND OF THE INVENTION

1. Field of the Invention

The present invention relates to a motor drive, and more specifically relates to a motor drive that can detect a DC link current.

2. Description of Related Art

In brushless DC motors, a permanent magnet is used as a rotor, while coils are used as a stator. The brushless DC motors adopt inverter control in which an inverter circuit controls the switching of currents flowing through the coils in accordance with the rotation of the motor. To the inverter circuit, a direct current is supplied. A fuse is provided between a direct current (DC) power source and the inverter circuit in order to prevent the occurrence of emitting smoke and the like in a circuit board (for example, Japanese Unexamined Patent Publication (Kokai) No. 2005-304145).

In the above conventional technique, an overcurrent is detected with the use of a voltage across the fuse, which is provided in a DC link unit for supplying the direct current, and the rotation of the motor is stopped or decelerated under PWM control. However, since power elements are not immediately turned off when detecting the overcurrent, the power elements may not be protected from the overcurrent.

### SUMMARY OF THE INVENTION

The present invention aims at providing a motor drive in which upon detecting that a DC link current flowing from a DC link unit to an inverter circuit is in an overcurrent state, an off signal is immediately supplied to power elements of the inverter circuit so that the power elements are turned off in order to be protected.

A motor drive according to an embodiment of the present invention includes an inverter circuit for converting a direct current (DC) supplied from terminals of a DC link unit into an alternating current by switching of a plurality of power elements, and supplying the alternating current to a motor; a drive circuit for controlling the switching of the plurality of power elements of the inverter circuit; a fuse connected in series between one of the terminals of the DC link unit and one of terminals of the inverter circuit through a conductor; a DC link current detection circuit for detecting a DC link current flowing from the terminal of the DC link unit to the inverter circuit based on at least one of a voltage across the fuse, a voltage across a circuit including the fuse and part of the conductor, and a voltage across part of the conductor; and a DC link overcurrent detection circuit for detecting that the DC link current is an overcurrent when the detected DC link current exceeds a predetermined current value, and outputting a power element off command to the drive circuit to turn off at least one of the plurality of power elements.

### BRIEF DESCRIPTION OF THE DRAWINGS

The objects, features, and advantages of the present invention will be more apparent from the following description of embodiments in conjunction with the attached drawings, wherein:

FIG. 1 is a block diagram of a motor drive according to a first embodiment of the present invention;

FIG. 2 is a block diagram of a first modification example of the motor drive according to the first embodiment of the present invention;

FIG. 3 is a block diagram of a second modification example of the motor drive according to the first embodiment of the present invention;

FIG. 4 is a flowchart that explains the operation process of the motor drive according to the first embodiment of the present invention;

FIG. 5 is a block diagram of a motor drive according to a second embodiment of the present invention; and

FIG. 6 is a flowchart that explains the operation process of the motor drive according to the second embodiment of the present invention.

### DETAILED DESCRIPTION OF THE INVENTION

A motor drive according to the present invention will be described below with reference to the drawings.

### First Embodiment

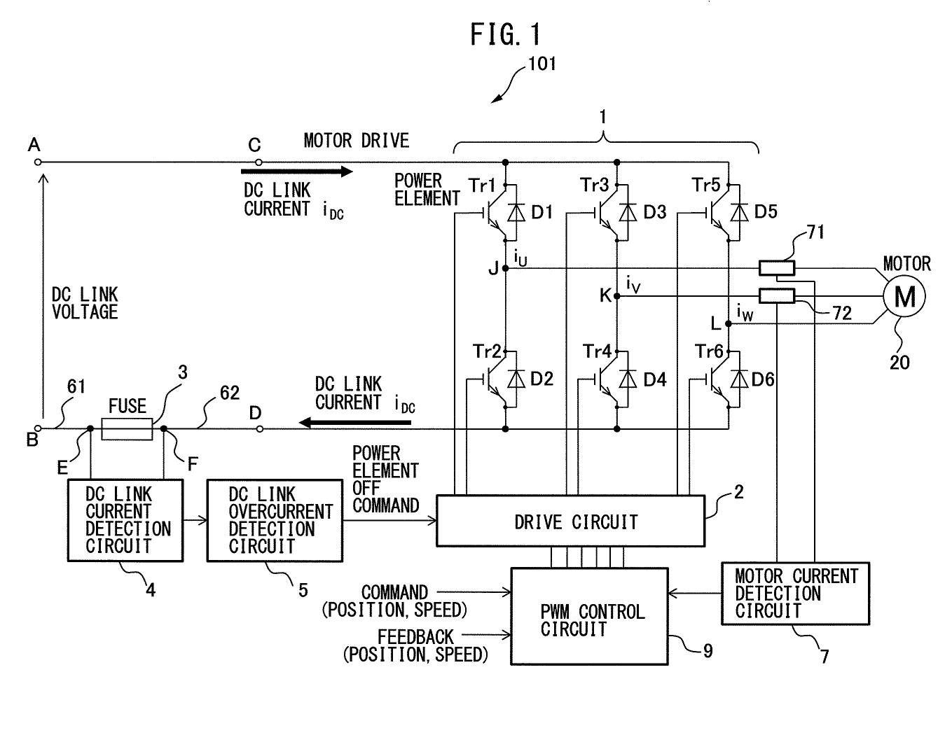

A motor drive according to a first embodiment of the present invention will be described with reference to the drawings. FIG. 1 is a block diagram of a motor drive 101 according to the first embodiment of the present invention. The motor drive 101 according to the first embodiment of the present invention has an inverter circuit 1, a drive circuit 2, a fuse 3, a DC link current detection circuit 4, and a DC link overcurrent detection circuit 5.

The inverter circuit 1 includes a plurality of power elements Tr1 to Tr6 and diodes D1 to D6. The inverter circuit 1 converts a direct current supplied from terminals A and B of a DC link unit (not shown) into an alternating current by the switching of the plurality of power elements Tr1 to Tr6, and supplies the alternating current to a motor 20. For example, in the motor drive for a three-phase motor, the inverter circuit 1 is constituted of six power elements Tr1 to Tr6 and six diodes D1 to D6. Transistors, FETs, IGBTs, or the like are available as the power elements Tr1 to Tr6.

Out of the six power elements Tr1 to Tr6, the Tr1 is a U-phase upper arm transistor and the Tr2 is a U-phase lower arm transistor. The Tr1 and the Tr2 are connected at a node J. A U-phase current iᵤ is supplied from the node J to the motor 20. A first current detector 71 detects the U-phase current iᵤ. The current value of the U-phase current iᵤ detected by the first current detector 71 is outputted to a motor current detection circuit 7.

Also, out of the six power elements Tr1 to Tr6, the Tr3 is a V-phase upper arm transistor and the Tr4 is a V-phase lower arm transistor. The Tr3 and the Tr4 are connected at a node K. A V-phase current iᵥ is supplied from the node K to the motor 20. A second current detector 72 detects the V-phase current iᵥ. The current value of the V-phase current iᵥ detected by the second current detector 72 is outputted to the motor current detection circuit 7.

Also, out of the six power elements Tr1 to Tr6, the Tr5 is a W-phase upper arm transistor and the Tr6 is a W-phase lower arm transistor. The Tr5 and the Tr6 are connected at a node L. A W-phase current i_{w} is supplied from the node L to the motor 20.

The drive circuit 2 controls the switching of the plurality of power elements Tr1 to Tr6 of the inverter circuit 1 based on a PWM signal from a PWM control circuit 9. The PWM control circuit 9 generates the PWM signal based on a position or speed command and position or speed feedback.

The fuse 3 is connected in series between the terminal B, i.e., one of the terminals A and B of the DC link unit and a terminal D, i.e., one of terminals of the inverter circuit 1 through conductors 61 and 62. However, the fuse 3 may be connected in series between the terminal A, i.e., the other of the terminals A and B of the DC link unit and a terminal C i.e. the other of the terminals of the inverter circuit 1 through conductors.

The DC link current detection circuit 4 detects a DC link current i_{DC} flowing from the terminal A or B of the DC link unit to the inverter circuit 1 based on a voltage across the fuse 3. To be more specific, the voltage between terminals E and F of the fuse 3 is measured, and the measured voltage value is divided by the resistance value of the fuse 3 to calculate the DC link current i_{DC}.

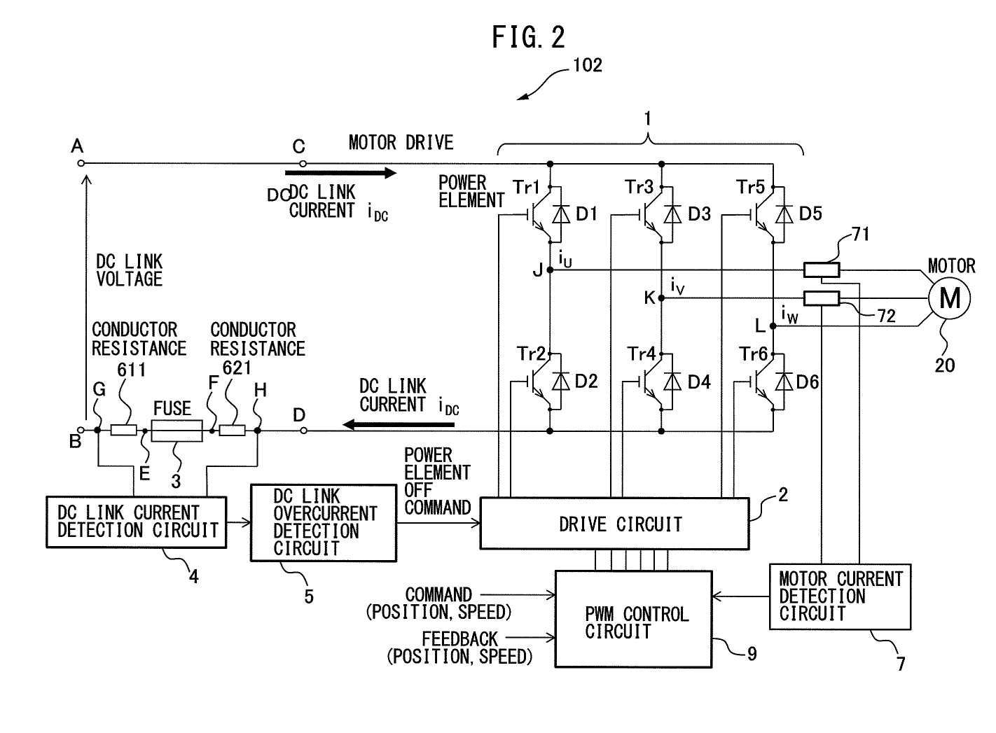

A method for calculating the DC link current i_{DC} is not limited to the above. FIG. 2 shows a motor drive 102 according to a first modification example of the first embodiment of the present invention. As shown in FIG. 2, the DC link current i_{DC} flowing from the terminal A or B of the DC link unit to the inverter circuit 1 may be detected based on a voltage across a circuit that includes the fuse 3 and part 611 and 621 of the conductors. To be more specific, the voltage between terminals G and H of the circuit that includes the fuse 3 and part 611 and 621 of the conductors is measured. The measured voltage value is divided by the resistance value of the fuse 3 and part 611 and 621 of the conductors to calculate the DC link current i_{DC}.

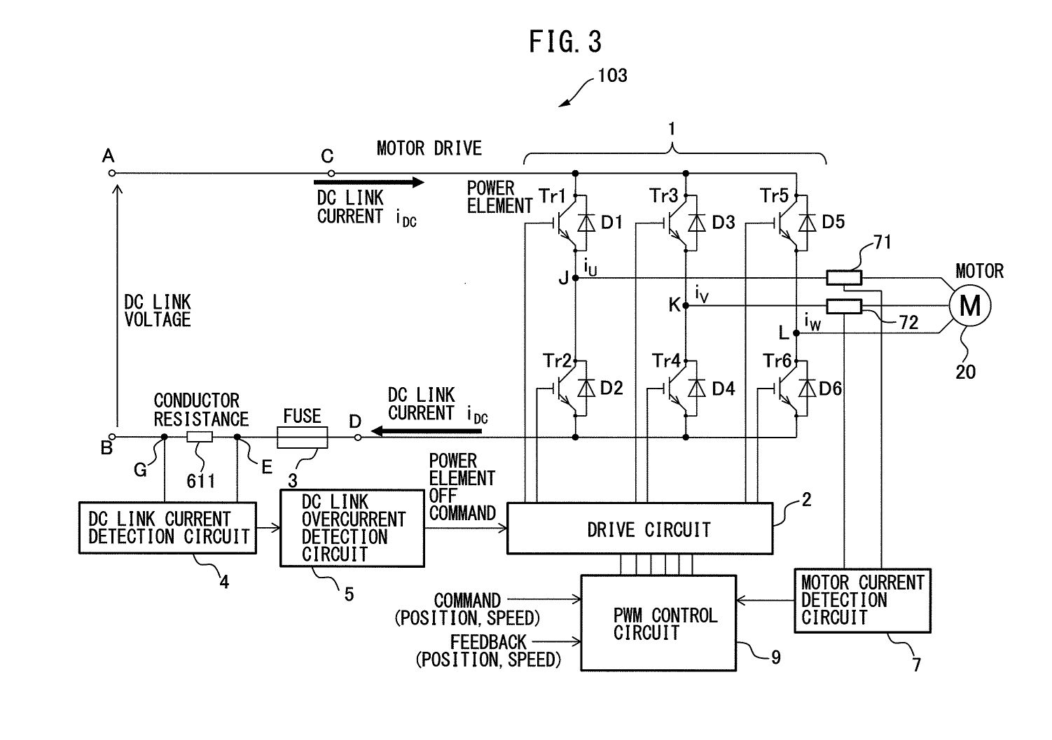

Furthermore, the method for calculating the DC link current i_{DC} is not limited to the above. FIG. 3 shows a motor drive 103 according to a second modification example of the first embodiment of the present invention. As shown in FIG. 3, the DC link current i_{DC} flowing from the terminal A or B of the DC link unit to the inverter circuit 1 may be detected based on a voltage across part 611 of the conductor. To be more specific, the voltage between a terminal G of part 611 of the conductor and the terminal E of the fuse 3 is measured. The measured voltage value is divided by the resistance value of part 611 of the conductor to calculate the DC link current i_{DC}. Note that, FIG. 3 shows an instance where the DC link current i_{DC} is calculated based on the voltage across part 611 of the conductor that is between the terminal B of the DC link unit and the terminal E of the fuse 3, by way of example. However, the method is not limited to this instance. That is to say, the DC link current i_{DC} may be calculated based on a voltage across part 621 of the conductor that is between the terminal D of the inverter circuit 1 and the terminal F of the fuse 3, as shown in FIG. 2.

In this manner, the DC link current detection circuit 4 detects the DC link current i_{DC} flowing from the terminal A or B of the DC link unit to the inverter circuit 1 based on at least one of the voltage across the fuse 3, the voltage across the circuit including the fuse 3 and part 611 and 621 of the conductors 61 and 62, the voltage across part 611 of the conductor 61, and the voltage across part 612 of the conductor 62.

When the detected DC link current i_{DC} exceeds a predetermined current value i_{TH}, the DC link overcurrent detection circuit 5 detects that the DC link current i_{DC} is an overcurrent, and outputs a power element off command to the drive circuit 2 to turn off at least one of the plurality of power elements Tr1 to Tr6. The predetermined current value i_{TH} is preferably set lower than a current value at which at least one of the plurality of power elements Tr1 to Tr6 breaks. Also, the predetermined current value i_{TH} may be set lower than a current value at which the fuse 3 is blown out.

In response to the power element off command from the DC link overcurrent detection circuit 5, the drive circuit 2 immediately applies an off signal to the power element in an on state, out of the power elements Tr1 to Tr6, without performing PWM control on the power element, in order to turn off the power element. As a result, the power elements Tr1 to Tr6 are protected from the overcurrent.

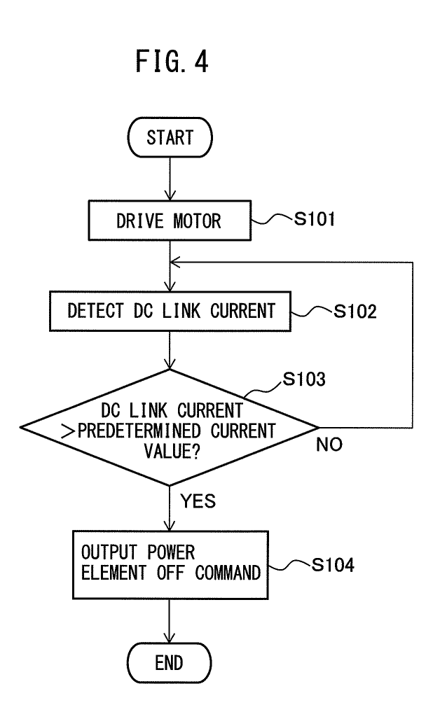

Next, a method for driving the motor drive according to the first embodiment of the present invention will be described. FIG. 4 is a flowchart that explains the operation process of the motor drive according to the first embodiment of the present invention. First, in step S101, the motor drive 101 drives the motor 20 (see FIG. 1). At this time, some (for example, two of the Tr1 and the Tr4) of the power elements Tr1 to Tr6 are in an on state, so that a DC link current i_{DC} flows from the terminal A of the DC link unit to the inverter circuit 1 through the terminal C.

Next, in step S102, the DC link current detection circuit 4 detects the DC link current i_{DC} that flows from the terminal D of the inverter circuit 1 to the terminal B of the DC link unit. It is assumed here that the DC link current i_{DC} flowing from the terminal D of the inverter circuit 1 to the terminal B of the DC link unit is equal to a current flowing through any one of the power elements Tr1 to Tr6. Data as to the value of the detected DC link current i_{DC} is outputted to the DC link overcurrent detection circuit 5.

Next, in step S103, the DC link overcurrent detection circuit 5 determines whether or not the DC link current i_{DC} is higher than the predetermined current value i_{TH}. The predetermined current value i_{TH} may be stored in advance in a memory (not shown).

When the DC link overcurrent detection circuit 5 determines that the DC link current i_{DC} is higher than the predetermined current value i_{TH}, the DC link current i_{DC} is determined to be an overcurrent state, and a power element off command is outputted to the drive circuit 2 to turn off at least one of power elements in an on state, out of the plurality of power elements Tr1 to Tr6.

On the other hand, when the DC link overcurrent detection circuit 5 determines that the DC link current i_{DC} is equal to or lower than the predetermined current value i_{TH}, the DC link current i_{DC} is not determined to be an overcurrent state. The operation returns to step S102, and a DC link current i_{DC} is detected while the motor 20 continues to be driven.

As described above, according to the motor drive of the first embodiment of the present invention, upon detecting that a DC link current is an overcurrent, an off signal is applied to the power elements, without performing PWM control on the power elements, so that the power elements are turned off. This allows protecting the power elements from the overcurrent.

### Second Embodiment

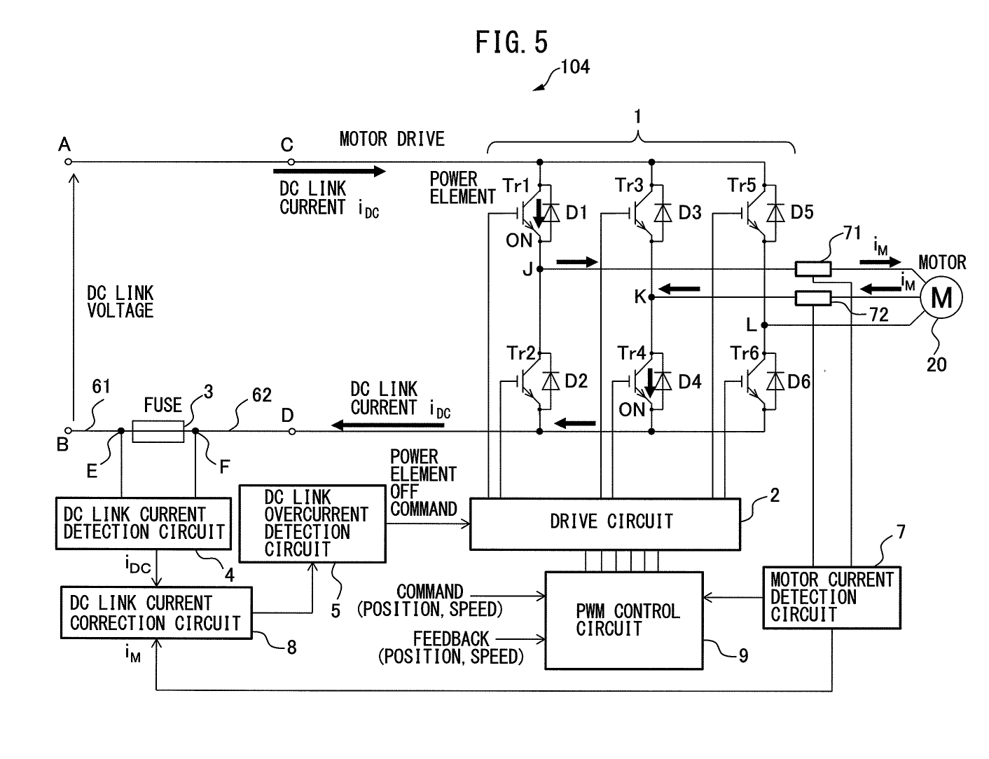

Next, a motor drive according to a second embodiment of the present invention will be described with reference to the drawings. FIG. 5 is a block diagram of a motor drive 104 according to the second embodiment of the present invention. The difference between the motor drive 104 of the second embodiment of the present invention and the motor drive 101 according to the first embodiment is that the motor drive 104 further includes a DC link current correction circuit 8. The other configurations of the motor drive 104 according to the second embodiment of the present invention are the same as those of the motor drive 101 according to the first embodiment, so a detailed description is omitted.

The motor current detection circuit 7 detects a motor current i_{M} flowing through the motor 20 when at least two of the plurality of power elements Tr1 to Tr6 are turned on at a stage (test mode) prior to driving (controlling) the motor. For example, in FIG. 5, the motor current detection circuit 7 detects the motor current i_{M} flowing through the motor 20, when the U-phase upper arm transistor Tr1 and the V-phase lower arm transistor Tr4 are turned on, while the other transistors are turned off.

In the example of FIG. 5, the U-phase upper arm transistor Tr1 is turned on, while the U-phase lower arm transistor Tr2 is turned off. Thus, as indicated by arrows, a DC link current i_{DC} flows from the terminal C of the inverter circuit 1 through the U-phase upper arm transistor Tr1, and is supplied from the node J to the motor 20 as a U-phase motor current i_{M}. The first current detector 71 detects the U-phase motor current i_{M}, and a detection result is outputted to the motor current detection circuit 7.

Also, in the example of FIG. 5, the V-phase upper arm transistor Tr3 is turned off, while the V-phase lower arm transistor Tr4 is turned on. Thus, as indicated by arrows, a current flows through the node K and the V-phase lower arm transistor Tr4 to the terminal D of the inverter circuit 1, as a V-phase motor current i_{M}. This current is detected by the DC link current detection circuit 4 provided between the terminal B of the DC link unit and the terminal D of the inverter circuit 1, as the DC link current i_{DC}.

The DC link current correction circuit 8 corrects the value of the DC link current i_{DC} so as to become equal to the value of the motor current i_{M}. More specifically, the DC link current correction circuit 8 obtains data as to the value of the motor current i_{M} from the motor current detection circuit 7, and obtains data as to the value of the DC link current i_{DC} from the DC link current detection circuit 4. The DC link current correction circuit 8 calculates a correction amount for the data as to the value of the DC link current i_{DC} detected by the DC link current detection circuit 4, on the basis of the data as to the value of the motor current i_{M} detected by the motor current detection circuit 7. The reason why the correction amount is calculated on the basis of the data as to the value of the motor current i_{M} detected by the motor current detection circuit 7 is that the data as to the value of the motor current i_{M} is closer to an actual current than the data as to the value of the DC link current i_{DC} detected by the DC link current detection circuit 4.

An instance where data as to the value of a motor current i_{M} detected by the motor current detection circuit 7 is 100 [A], while data as to the value of a DC link current i_{DC} detected by the DC link current detection circuit 4 is 101 [A] is taken as an example. In this instance, 100/101 is set as a correction amount, and the product of the data on the value of the DC link current i_{DC} detected by the DC link current detection circuit 4 and 100/101 is set as a DC link current i_{DC}. The DC link current correction circuit 8 outputs the value of the corrected DC link current i_{DC} to the DC link overcurrent detection circuit 5.

After that, when the corrected DC link current i_{DC} exceeds a predetermined current value, the DC link overcurrent detection circuit 5 detects that the DC link current i_{DC} is an overcurrent, and outputs a power element off command to the drive circuit 2 to turn off at least one of power elements in an on state, out of the plurality of power elements Tr1 to Tr6.

In response to the power element off command from the DC link overcurrent detection circuit 5, the drive circuit 2 immediately applies an off signal to the power element, without performing PWM control on the power element, to turn off the power element. As a result, the power elements Tr1 to Tr6 are protected from the overcurrent.

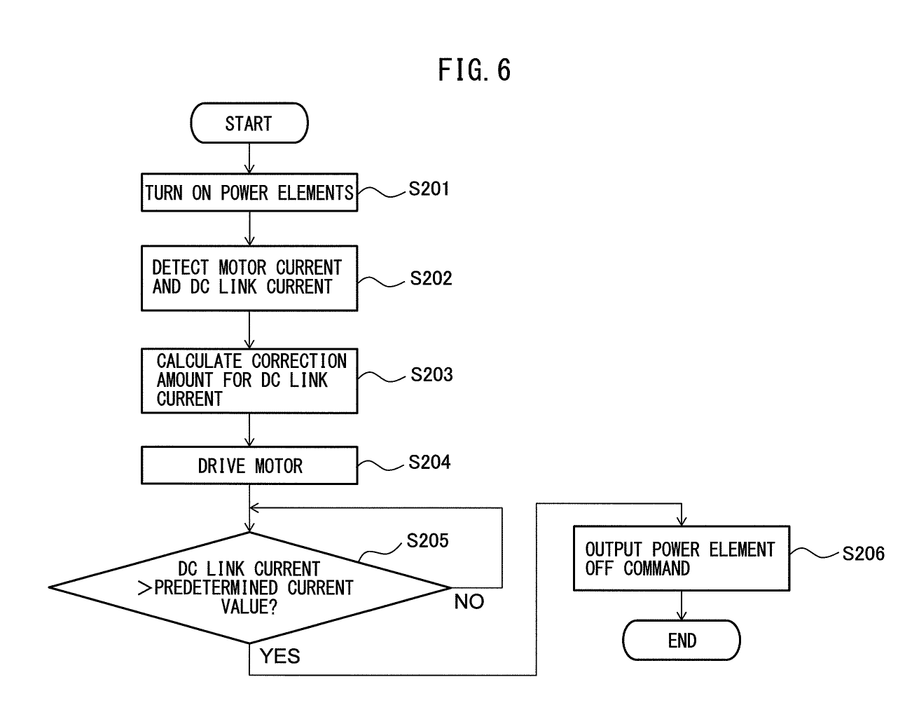

Next, a method for correcting a DC link current of the motor drive according to the second embodiment of the present invention will be described. FIG. 6 is a flowchart that explains the operation process of the motor drive according to the second embodiment of the present invention. First, in step S201, at least two of the plurality of power elements Tr1 to Tr6 are turned on. For example, as shown in FIG. 5, the U-phase upper arm transistor Tr1 and the V-phase lower arm transistor Tr4 of the inverter circuit 1 are turned on, so that a DC link current i_{DC} flows from the terminal A of the DC link unit to the inverter circuit 1.

Next, in step S202, the first current detector 71 detects a motor current i_{M} flowing from the inverter circuit 1 to the motor 20. Data as to the value of the detected motor current i_{M} is outputted through the motor current detection circuit 7 to the DC link current correction circuit 8.

At the same time, the DC link current detection circuit 4 detects a DC link current i_{DC} flowing from the terminal D of the inverter circuit 1 to the terminal B of the DC link unit based on a voltage between the terminals E and F of the fuse 3. Data as to the value of the detected DC link current i_{DC} is outputted to the DC link current correction circuit 8.

Next, in step S203, a correction amount for the data as to the value of the DC link current i_{DC} detected by the DC link current detection circuit 4 is calculated with respect to the data as to the value of the motor current i_{M} detected by the motor current detection circuit 7. At this time, the correction amount is stored in the DC link current correction circuit 8.

Next, in step S204, the drive of the motor is started.

Next, the DC link current correction circuit 8 calculates the product of the data detected by the DC link current detection circuit 4 and the above-described correction amount. The product is sent to the DC link overcurrent detection circuit 5 as a DC link current i_{DC}. In step S205, whether or not the corrected DC link current i_{DC} exceeds a predetermined current value i_{TH} is determined. When the value of the DC link current i_{DC} is determined to exceed the predetermined current value i_{TH}, in step S206, the DC link current i_{DC} is determined to be in an overcurrent state, and a power element off command is outputted to the drive circuit 2 in order to turn off at least one of power elements in an on state, out of the plurality of power elements Tr1 to Tr6.

On the other hand, when the DC link overcurrent detection circuit 5 determines that the DC link current i_{DC} is equal to or lower than the predetermined current value i_{TH}, the operation returns between step S204 and step S205, and a DC link current i_{DC} is detected while the motor 20 continues to be driven.

As described above, according to the motor drive of the second embodiment of the present invention, the value of a detected DC link current i_{DC} is compared with the value of a motor current i_{M} that actually flows through the motor, and the detected DC link current i_{DC} is corrected so as to become equal to the motor current i_{M}. After that, whether or not the corrected DC link current i_{DC} is in an overcurrent state is detected, thus allowing determination of the presence or absence of an overcurrent state with high precision.

According to the motor drives of the embodiments of the present invention, upon detecting that a DC link current flowing from the DC link unit to the inverter circuit is an overcurrent, an off signal is immediately applied to the power element of the inverter circuit to turn off the power element, instead of performing PWM control on the inverter circuit, thus allowing protection of the power elements.

What is claimed is:

1. A motor drive comprising:
an inverter circuit for converting a direct current supplied from terminals of a DC link unit into an alternating current by the switching of a plurality of power elements, and supplying the alternating current to a motor;
a drive circuit for controlling the switching of the plurality of power elements of the inverter circuit;
a fuse connected in series between one of the terminals of the DC link unit and one of terminals of the inverter circuit through a conductor;
a DC link current detection circuit for detecting a DC link current flowing from the terminal of the DC link unit to the inverter circuit based on at least one of a voltage across the fuse, a voltage across a circuit including the fuse and part of the conductor, and a voltage across part of the conductor; and
a DC link overcurrent detection circuit for detecting that the DC link current is an overcurrent when the detected DC link current exceeds a predetermined current value, and outputting a power element off command to the drive circuit in order to turn off at least one of the plurality of power elements.

2. The motor drive according to claim 1, further comprising:
a motor current detection circuit for detecting a motor current flowing through the motor when at least two of the plurality of power elements are turned on; and
a DC link current correction circuit for correcting the value of the DC link current so as to become equal to the value of the motor current.
